(19) United States
(12) Patent Application Publication
(10) Pub. No.: US 2002/0073562 A1
(43) Pub. Date: Jun. 20, 2002

(54) Device and method for surveying in low light conditions

(76) Inventor: Jeffrey H. Brink, Littleton, CO (US)

Correspondence Address: SHERIDAN ROSS PC, 1560 BROADWAY, SUITE 1200, DENVER, CO, 80202

(21) Appl. No.: 09/741,242

(22) Filed: Dec. 18, 2000

(51) Int. Cl. G01C 15/06

(52) U.S. Cl. 33/293

(57) ABSTRACT

A lighted survey rod of the present invention comprises an extended member having measurement indicia included thereon, a series of light emanating sources positioned along the member so that the light emanating therefrom provides a surveyor with the ability to observe and record surveying measurements in low light and/or night time surveying conditions. In a preferred embodiment, a battery source powers light emanating elements evenly spaced along the extent of a survey rod, illuminating measurement markings along such rod. Different intensities and/or colors of lights, luminescent material, etc. can be used to indicate measurements along the rod. Mirrored surfaces can be used to further enhance the visual characteristics of light emanating from the lighted surveying rod of the present invention. Still further embodiments comprise multi-sided surveying rods having a central cavity through which a lighted insert can be provided which illuminates desired portions of such rod, thereby facilitating night time and/or low light surveying operations.

### FIELD OF THE INVENTION

The present invention is directed to a method and device for performing a variety of surveys in low light conditions, and in particular, is directed to a lighted survey rod that can be viewed through a surveying scope even in low ambient light conditions.

### BACKGROUND OF THE INVENTION

In typical surveying operations, a surveying scope or transit is focused upon a distant survey rod held in a vertical or horizontal position, such rod provided with indicia representing known units of length. A surveyor looks along the line of sight between the sighting instrument and the rod to determine ground contours, other elevations and/or boundaries. Surveying rods are typically painted a white or alternate red and white color with black measured markings imprinted thereon, such color contrast making it easier for a surveyor to view the surveying rods from long distances. A problem in the surveying art relates to the inability to visualize a surveying rod over long distances under low ambient light conditions. Such conditions exist, for example, at twilight, at dusk, at night, in tunnels, caves, enclosed structures, under water, etc. where ambient lighting is insufficient to permit accurate surveys to be conducted.

Difficulties in ground based surveying in low light or night conditions has been recognized by previous investigators and various methods and systems have been developed in an attempt to overcome such problems. For example, U.S. Pat. No. 5,027,521 to DelGiorgio describes an apparatus for surveying during nighttime. DelGiorgio's apparatus and system, however, relies upon an illumination source which is reflected by a reflector surface which is slidably adjusted on a frame so that a longitudinal axis of a light beam is parallel to a selected vertically oriented axis. Other systems utilize laser light which is transmitted generally from the surveying scope and is reflected off of a reflector positioned on a surveying rod. For example, Japanese Patent Application No. JP 11230755 utilizes lasers in such a manner. (See, e.g., U.S. Pat. No. 6,023,326 to Yasutaka; U.S. Pat. No. 5,631,732 to Schrum and U.S. Pat. No. 5,091,627 to Kimura). U.S. Pat. No. 4,644,611 to Bozzolato describes a three-conical signal for industrial surveys in which light is directed upwardly through a vertical cylindrical axial bore to provide an illuminous mark at a collimation point. The light used in the Bozzolato system is used to illuminate, by reflection, an upper conical cap and is therefore not used to illuminate a measuring rod which can then be read by surveying equipment. Such device is also of a complicated design and construction and is ill-suited for use in many typical survey operations.

Still other prior investigators have used light sources provided on the survey instrument itself, such as a level or a transit, so that a point to be surveyed is made visible in the dark by shining a beam in the rod's direction (i.e., Japanese Application No. JP 5215549). Still others have utilized a field land survey light adapted for securement between a target and a prism (e.g., U.S. Pat. No. 5,419,052 to Goller).

While some prior art investigators have disclosed survey targets with high intensity discharge lamps associated therewith, such devices are expensive to produce, are adapted for use with filters to produce a lamp of a predetermined wavelength, and are thus expensive and not suitable for many surveying operations in low ambient light conditions (e.g., U.S. Pat. No. 4,866,849 to Parra; see also, U.S. Pat. No. 4,796,040).

In view of the above, there is a long-felt but unsolved need for a simple and effective device and method that permits surveying in low ambient light conditions, such method and device preferably not employing expensive laser lights, powerful spot lights, etc. As described hereinbelow, the present invention satisfies this long-felt need.

### SUMMARY OF THE INVENTION

The present invention is directed to a lighted survey rod comprising an elongated member having measurement markings thereon and a light source operatively associated with the member that facilitates visualization of such markings by a surveyor at a distance and under low ambient light conditions.

The survey rod preferably has at least two faces, with each of said faces having distinct measurement markings thereon, and more preferably that has at least one face that comprises transparent components through which the light source, when illuminated, can shine through.

The survey rod may be comprised of at least two segments in a telescoping association and the light source may comprise an attachable strip having light emanating sources operatively associated therewith, such light source selected from the group consisting of fiberoptic elements, incandescent lights, and luminescent material.

In other embodiments the survey rod may include mirrored surfaces operatively associated with the light source to enhance the luminosity thereof.

In still other embodiments, the survey rod has a hollow interior and the light source comprises an element insertable into such interior. The light source preferably comprises a plurality of equally spaced light emitting elements, such elements arranged in a manner so as to indicate measurement positions along the rod. A power source can be operatively associated with such light emitting elements, which are preferably arranged in close proximity to measurement markings such that a surveyor can determine a measurement by visualizing one of the markings when they are illuminated by one of the light source elements. The light source elements may have distinct colors and/or may have varying intensity of light corresponding to incremental measurements (such as one foot intervals).

### BRIEF DESCRIPTION OF THE DRAWINGS

FIG. 1 is an illustration of one embodiment of the present invention wherein a power source is located at one end of the lighted rod and light emanating sources are substantially evenly spaced along the extent of the rod.

FIG. 2 is an illustration of a three-sided lighted rod of the present invention showing a graduated lighted insert rod in an exploded view.

FIG. 3 shows one embodiment of the present invention with a rounded surface and having a light stick associated therewith to illuminate the markings imprinted thereon.

FIG. 4 shows another embodiment of the present invention wherein the rod is oval in shape and has an applique graduated light filament retrofitably attachable to the rod.

FIG. 5 shows another embodiment of the present invention having telescoping members, thus affording contraction and extension of the surveying rod to facilitate surveying greater vertical distances, easy storage and/or transport.

FIG. 6 illustrates one embodiment of the present invention wherein measurement markings 16a are in luminescent paint and light sources 14 of an incandescent nature are also provided.

FIG. 7 illustrates one embodiment of the present invention in which parabolic reflector devices 15 are provided to enhance and/or direct the light emanating from the incremental light sources 14.

### DETAILED DESCRIPTION OF THE INVENTION

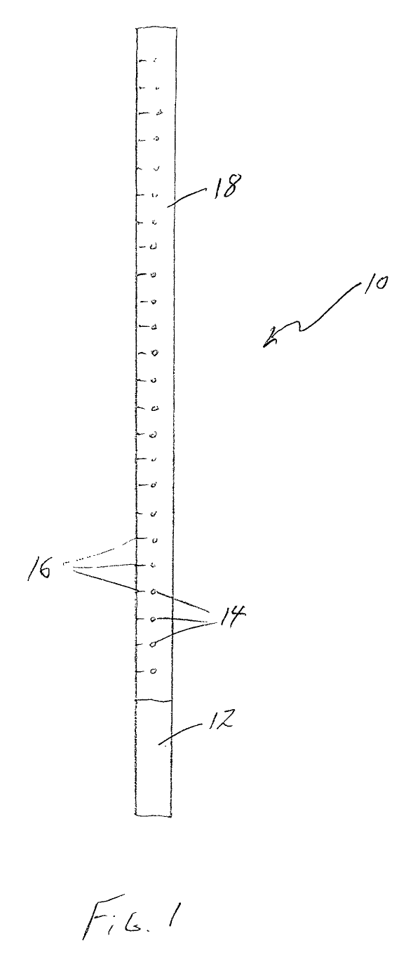

The present invention is directed to a survey rod 10 that can be viewed at distances under low ambient light conditions. In general, the present invention is directed to one of many various embodiments by which the survey rod device 10 is provided with a luminescent source, whether that be luminescent material such as glow in the dark markings, or, more preferably, actual light sources powered by a power source such as a battery, stored solar energy, electric generators, chemical luminescent material, or other suitable energy sources. In one particular embodiment, light source markings 14 are spaced apart in a predetermined fashion along a substantial extent of the survey rod 18, such survey rod having separate and distinct markings and/or calibrations 16 thereon. As shown in FIG. 1, a power source 12 (e.g., batteries) can be provided in operative association with the device 10, preferably positioned at one end of the device 10.

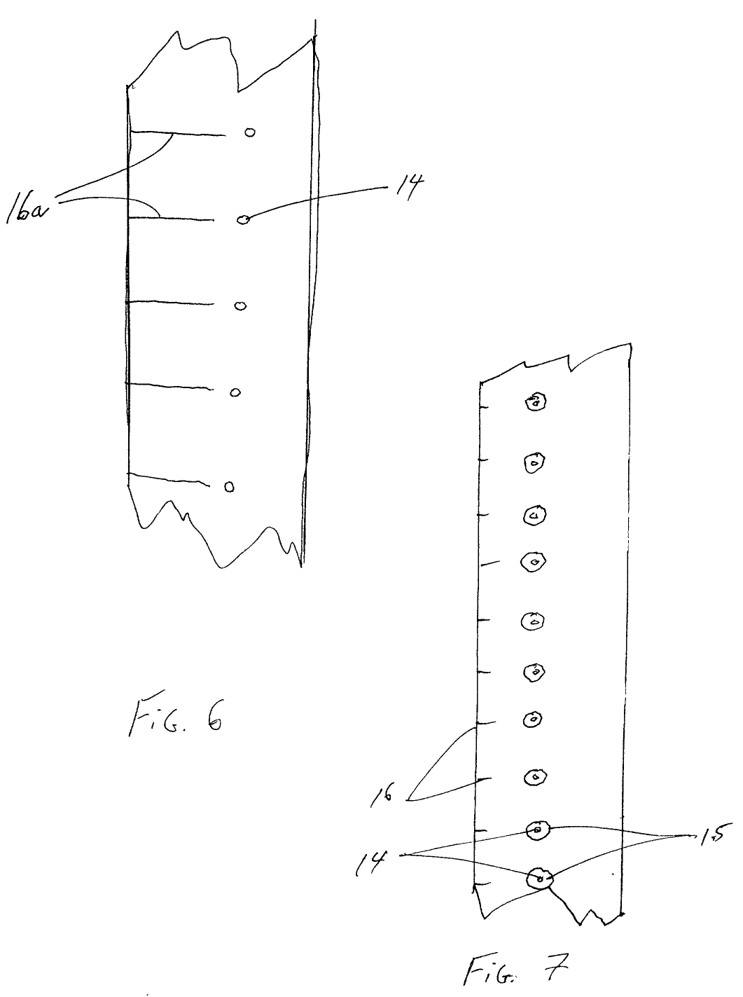

As one of skill in the art will appreciate, the particular light sources 14 provided in an elongated and predetermined array along the length of the rod 18 may, for example, be fiberoptic light sources, incandescent light sources, and/or luminescent sources, or a combination thereof. Indeed, in one particular embodiment, luminescent paint and/or markings are used in combination with either a fiberoptic and/or an incandescent light source so that, at the surveyor's option, the survey rod 10 of the present invention can be used with or without the incandescent and/or fiberoptic light sources turned on, depending on whether the luminescent markings 14 on the rod 18 are sufficient to achieve desired results in a survey operation conducted under low ambient light conditions. FIG. 6 illustrates one embodiment of the present invention wherein an incandescent and/or fiberoptic light source 14 is used in combination with luminescent markings 16a.

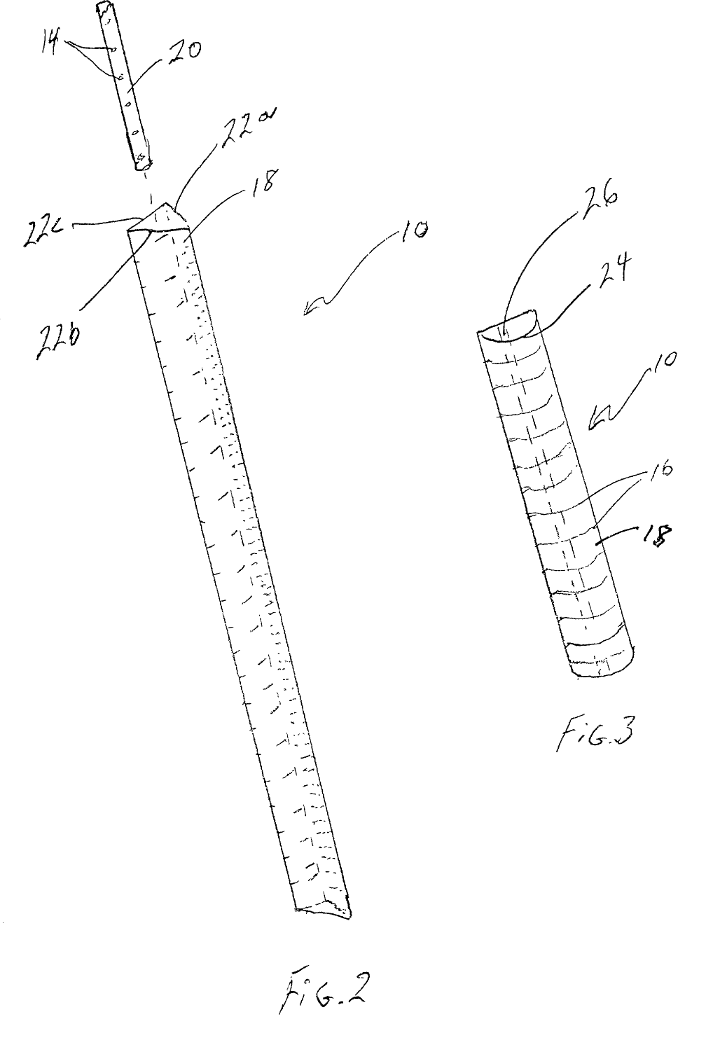

With reference to FIG. 2, various embodiments of the present invention entail the use of a polysided rod 18 having, for example, three separate faces 22a,b,c, each of such faces having different measurement markings (such as English and/or metric measurements) and/or distinct color patterns (e.g., red, white, black, or combinations thereof). Moreover, in one embodiment, various sides 22a,b,c of the surveying rod 18 can have identical measurements (e.g., either English and/or metric), however, each face 22a,b,c is provided with differing light sources. For example, 22a may be provided with luminescent paint markings, 22b can be provided with incandescent light sources and 22c can be provided with fiberoptic light sources, thus providing a surveyor with a variety of options in particular low ambient light environments (e.g., caves, tunnels, night time, etc.). Moreover, one of the multiple sides could be painted white so as to be used during traditional daytime surveying.

As illustrated in FIG. 2, in one particular embodiment to the present invention, a light emitting insert 22 is provided having spaced apart light sources 14 provided thereon. The insert 20 is inserted into a hollow interior of the survey rod 18, such rod 18 having either apertures (not shown) at appropriate positions so as to permit the light sources 14 on the insert 20 to shine through, or one or more of the faces 22a,b,c may comprise transparent material to permit light emanating from such light sources 14 to shine therethrough.

As one of skill in the art will appreciate, the survey rod 18 of the present invention can be of any desired shape, and may, in certain embodiments, have various straight sides and/or curved sides to facilitate different markings and/or to provide additional strength in the overall extent of the rod 18.

With reference to FIG. 3, in one particular embodiment of the present invention, at least one face 24 of the rod 18 is curved. An illuminating insert 26 is provided so that it runs the extent of the rod 18 and provides light illumination along and/or through the curved surface 24, thus permitting illumination and visualization of markings 16 along the extent of the rod 18. In one embodiment, instead of an insert 26 being provided, luminescent paint and or tape is provided along the extent of the rod 18, thus providing the necessary light source in order to visualize the discreet markings 16 of the rod 18.

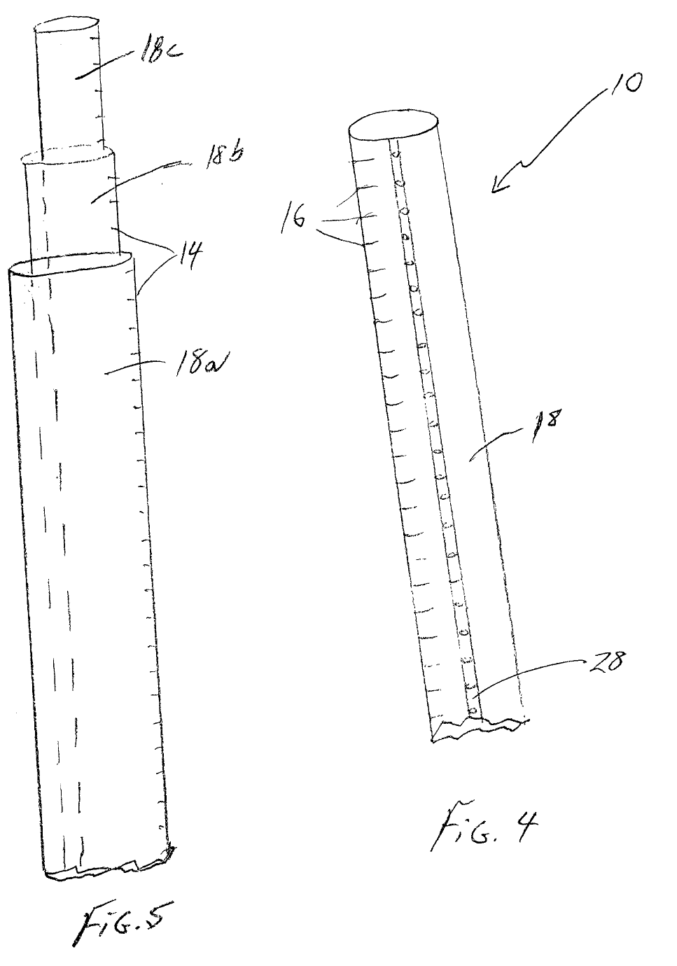

In yet another embodiment of the present invention illustrated in FIG. 4, the rod 18 can be of an oval shape with marking indications 16 provided along its extent. An applique light strip 28 can be applied to the exterior of the rod 18, thus providing a way to retrofit existing survey rods so as to make them suitable for use in low ambient light environments. The applique light source can be operatively associated with a power source, such as a battery, in order that the light sources can be illuminated once the applique is attached to the rod 18. Alternatively, or in addition to other light sources, the applique can be provided with luminescent markings thereon such that adhesive contact between the light strip 28 and the rod facilitates the goal of providing illumination of the discrete markings 16 along the extent of the rod 18. Any suitable means can be used to retrofit existing survey rods to achieve desired lumination thereof, including, but not limited to provision of adhesive strips of light sources, channeled/slip-on attachments to accommodate a light source strip, as well as other attachment means such as snaps, sleeves, tape, inserts, etc.

As illustrated in FIG. 5, the present invention can be used in combination with telescoping rod members 18a,b,c, thus facilitating a collapsible survey rod 18 making transport, carrying and use easier for a surveyor. As one will appreciate, various configurations of the present invention can be used in conjunction with a telescoping embodiment. For example, an insert light source 20 (as illustrated in FIG. 2) can be used in conjunction with the telescoping embodiment as pictured in FIG. 5. Similarly, the applique light source 28 (as pictured in FIG. 4) can be used in conjunction with the telescopic survey rod 18a,b,c as illustrated in FIG. 5.

In a still further embodiment to the present invention as shown in FIG. 6, luminescent paint 16a is used in discreet and predetermined positions along the extent of the rod 18, thus providing the luminescence required to view markings 16a on the survey rod 18 in low light conditions. In a preferred embodiment, a luminescent mark is present for each unit of measurement indicated on the rod 18. Typically such luminescent paint must be “charged” with a light source so that the luminescent paint 16a can store appropriate amounts of energy to provide luminescent capabilities at a later time in low light conditions.

In a further embodiment of the present invention, a survey rod 18 of the present invention can be provided with a hollow tube running the extent of the device 10 into which luminescent materials can be added to provide desired light energy. In one particular embodiment, a survey rod is provided with a capsule of luminescent chemicals which, when appropriately activated (by twisting the capsule to bring disparate chemicals into contact with each other) desired luminescence is achieved along the extent of the rod 18. In such an embodiment, there is no need for an independent power source, such as a battery, in order to achieve illumination of survey markings along the rod 18.

In still further embodiments of the present invention as shown in FIG. 7, mirrored surfaces 15 can be used to further enhance and/or amplify and/or direct the light emanating from the light sources 14 distributed along the extent of the survey rod 18. For example, concave and/or parabolic mirrored depressions can be formed around each individual point of light 14 to thus enhance the illumination effect and to concentrate the light source for easier viewing from a distance.

One aspect of the present invention is directed to a method for using a lighted survey rod 10. Pursuant to such method, a surveyor, whether working alone or with an assistant, positions the survey rod 18 at an appropriate location within a visual plane of a survey device, such as a surveyor scope. The lighted device 10 of the present invention is activated, for example, by permitting light sources 14 along the extent of the survey rod 18 to be illuminated by turning on a power source, such as by activating batteries 12 to provide power to the light sources 14. The survey rod device 10 is then manipulated in a desired manner to facilitate a reading by the surveyor through a distant surveying device, the energized light sources 14 providing the necessary illumination of the discreet markings 16 along the extent of the survey rod 18 so that the surveyor can more easily detect and determine appropriate measurements.

In a further embodiment of the present invention, light emitting elements 14 can be provided in different colors so as to indicate particular measurement indicia along the extent of said member. For example, a white emitting light source 14 may be provided at each foot measurement along a rod member 18, a yellow light source 14 can be provided at each half foot measurement indicia, a red light source 14 can be positioned corresponding to each inch measurement, etc.

In one embodiment, the extended rod member 18 is constructed of PVC material, with at least a portion thereof being clear and a further portion painted white (or other color) with a scale imprinted thereon, thus providing a device that can be used during the day, as well as in low light and/or night time conditions. Preferably, the device 10 is made in a way so as to be air and water tight, thus providing for use under water, underground, in space and/or in environmental conditions where water may potentially interfere with a surveying operation (e.g., foggy conditions, rain and snow conditions, etc.).

In a preferred embodiment, a push button switch and/or slide switch (not shown) is provided (e.g., on the top; bottom and/or 3 to 5 feet off of the ground, etc.) so as to facilitate easy operation by a surveyor and/or his/her assistant. The switch activates the power source 12 and thereby illuminates the lighting elements along the extent of the member 18. In a further embodiment of the present invention, instead of the light source elements 14 being disparate and placed in an ordered array along the extent of a member, thereby indicating measurement units, a solid light bar (not shown) is provided to light the measurement indicia present on the rod member 18. For example, a fiberoptic tube (not shown) can be provided so that light is transmitted from a first end of the device to the second end of the device 10, illuminating the marking indica 16 along the full extent of the member 18.

In a still further embodiment to the present invention, a flashlight mechanism (not shown) is provided at one end of the device 10, thus facilitating the placement and/or positioning of the rod in low light and/or night time conditions. Thereafter, the device 10 can be activated so as to trigger the power source 12, resulting in the emanation of light from the device in one or more of the embodiments as described herein.

Various other devices can be operatively associated with the lighted survey rod device 10 of the present invention, for example, levels (not shown) can be operatively associated with the rod 18 so as to more properly determine the angular orientation of the rod member in relation to the terrain being surveyed. Extendable static support members (not shown) can be operatively associated with the survey rod 18 so as to maintain the rod 18 in a desired orientation, for example, a substantially vertical orientation, thus permitting a one man operation. In other words, the survey rod 18 of the present invention can be properly positioned by a single surveyor and the surveyor can then depart a distance to the survey scope to view the prepositioned survey rod 10.

In one embodiment, the intensity of illumination from the light emitting elements 14 can also be adjusted depending upon the low light and/or night time conditions and/or to comport with a surveyor's personal preference with respect to how intense the light emanating light source elements 14 should be in any particular operation. A typical dimming switch and/or knob can be used for this purpose. Indeed, in one embodiment, the power source 12 can be remotely controlled so as to permit a surveyor to turn on, off, up, etc. the light sources 14 from a distance.

The surveying rod 10 of the present invention can be provided in any suitable length, for example, 25 foot rods, as well as rods as short as 3 feet, and may further be extendible by telescopic means to achieve any desired length. The shape of the rod 10 can be of any suitable type, including, but not limited to, oval, fiberglass constructed rods, circular rods, rectangular rods, etc. Rods 18 are preferably made from a strong, corrosion-proof material, such as PVC treated wood, plastic, metal and/or fiberglass that is light weight and easy to carry and is not subject to warping or swelling. Oval shaped rods are believed to offer better stability than other shaped rods. In particular embodiments, however, various geometric shaped rods 18 can be utilized, for example, various polygonic rod shapes such as triangular rods, octangular rods, etc. Indeed, various different types of measurement indicia can be indicated on each face, for example, English units can be placed on one surface, whereas metric measurements can be placed on another, and colored indicia indicated on still another surface, etc. Graduations can be screen printed thereon or otherwise imprinted using techniques known in the art for permanently bonding onto the surface of such rods 18.

Measurement indicia 16 imprinted and/or otherwise applied to the surface of the surveying rod 10 may consist of various colors and/or numerals imprinted thereon. The markings may be replaced with new inserts, etc. In a preferred embodiment, such graduations are protected by a plastic or epoxy coating for maximum wear resistance and are sized for maximum readability. In telescoping embodiments and/or collapsible surveying rods of the present invention, lower sections can be cushioned with glides to prevent wear.

Preferably, the rods 10 of the present invention are suitable for one man measurements and can therefore extend to up to over 50 feet and retract to less than 5 feet for storage. In some embodiments, the measurement markings 16 are recessed for wear protection and are epoxy-coated to resist fading and aberrations. In addition to telescopic sections 22a,b,c, different embodiments of the present invention can feature snap together and/or foldable joint sections that lock securely and separate easily for maintenance.

To provide background information that may be useful in conjunction with the description as provided herein, Applicants incorporate herein by reference in their entireties the following U.S. Patents: U.S. Pat. Nos. 4,625,473; 4,366,940; 4,146,969; 4,060,909 and 3,638,317. As one of ordinary skill in the art will appreciate, the various features described in the above-referenced patents can be utilized in combination with the present invention as herein described, and thus form the basis of the present invention.

While various embodiments of the present invention have been described in detail, it is apparent that further modifications and adaptations of the invention will occur to those skilled in the art. However, it is to be expressly understood that such modifications and adaptations are within the spirit and scope of the present invention.

What is claimed is:

1. A lighted survey rod, comprising:
a. an elongated member having a first end and a second end, said elongated member having measurement markings thereon; and
b. a light source operatively associated with said member whereby said light source illuminates said markings, thereby facilitating visualization of said markings by a surveyor at a distance and under low ambient light conditions.

2. The survey rod as set forth in claim 1, wherein said member has at least two faces, with each of said faces having distinct measurement markings thereon.

3. The survey rod as set forth in claim 1, wherein said member has a rounded face.

4. The survey rod as set forth in claim 1, wherein said member has at least three separate faces.

5. The survey rod as set forth in claim 1, wherein said member has at least one face that comprises transparent components through which said light source, when illuminated, can shine through.

6. The survey rod as set forth in claim 1, wherein said member is comprised of at least two segments, said segments being in a telescoping association.

7. The survey rod as set forth in claim 1, wherein said light source comprises an attachable strip having light emanating sources operatively associated therewith.

8. The survey rod as set forth in claim 1, wherein said light source is selected from the group consisting of fiberoptic elements, incandescent lights, and luminescent material.

9. The survey rod as set forth in claim 1, further comprising mirrored surfaces operatively associated with said light source to enhance the luminosity of said light source.

10. The survey rod as set forth in claim 1, wherein said light source comprises a luminescent marking and a light emanating device selected from the group consisting of an incandescent light and a fiberoptic light element.

11. The survey rod as set forth in claim 1, wherein said member comprises a hollow interior and said light source comprises an element insertable into said interior.

12. The survey rod as set forth in claim 1, wherein said light source comprises a plurality of equally spaced light emitting elements, said elements arranged in a manner so as to indicate measurement positions along said member.

13. A lighted survey rod, comprising:
a. an elongated member having first and second ends and having measurement markings provided thereon;
b. a power source operatively associated with said first end of said member;
c. a plurality of light emitting elements operatively associated with said power source, said light emitting elements arranged in close proximity to said measurement markings such that a surveyor can determine a measurement as indicated on said member by either:
(1) visualizing one of said markings on said member when said one of said markings is illuminated by one of said light source elements; or
(2) visualizing at least one of said light source elements which is positioned to provide visual information relating to a measurement along said member.

14. The survey rod as set forth in claim 13, wherein said light source elements have distinct colors.

15. The survey rod as set forth in claim 13, wherein said light source elements have varying intensity of light corresponding to incremental measurements as indicated between said first and second ends of said member.
